(19) United States
(12) Patent Application Publication
(10) Pub. No.: US 2003/0132852 A1
(43) Pub. Date: Jul. 17, 2003

(54) Illuminated emergency signaling device

(76) Inventors: Philip Francis Povey, Mission Viejo, CA (US); Christopher Allen Westlake, Aliso Viejo, CA (US)

Correspondence Address: Kit M. Stetina, Esq., STETINA BRUNDA GARRED & BRUCKER, 75 Enterprise, Suite 250, Aliso Viejo, CA, 92656, US

(21) Appl. No.: 10/324,583

(22) Filed: Dec. 19, 2002

Related U.S. Application Data
(63) Continuation-in-part of application No. 10/050,194, filed on Jan. 16, 2002, now Pat. No. 6,549,121.

(51) Int. Cl. G08B 5/22

(52) U.S. Cl. 340/815.45; 340/573.1; 340/983; 340/425.5

(57) ABSTRACT

A battery-powered emergency signaling device including a housing which encloses a battery pack disposed for providing power to the device. The housing can take on a variety of shapes. At least one light emitting diode (“LED”) pulsed by an electronic circuit, which LED is powered by a battery within the battery pack. A race is disposed about the housing for reflecting light received from the LED. The cover includes support members disposed between the base plate and the cover for providing strength to the device. An anchoring member is attached to the housing, thereby allowing the device to be mounted on a traffic cone. Also, the device includes a switch that turns the device on or off, thereby prolonging the useful life of the device.

### CROSS-REFERENCE TO RELATED APPLICATIONS

This is a Continuation-in-Part of application Ser. No. 10/050,194, filed Jan. 16, 2002, which is incorporated herein in its entirety.

### STATEMENT RE: FEDERALLY SPONSORED RESEARCH/DEVELOPMENT

(Not Applicable)

### BACKGROUND OF THE INVENTION

The present invention relates to the field of emergency signal lighting and in particular to an improved, light weight, self-contained emergency flashing beacon.

In the event of vehicular, aircraft or recreational boating accident or other emergency situation, emergency vehicles and personnel must respond to situations where it is difficult to locate the actual scene of the accident or emergency. Further, there is frequently no means available at an emergency site to ward off unwary passers-by from falling prey to possible dangers existing at the emergency site.

Markings or other representations for identifying an emergency site are seldom lit or are not easily visible. As a result, emergency personnel or vehicles can easily miss a geographic marking of a building from the street. Should the emergency arise in a desolate location, such marking may be entirely missing and emergency personnel may have further difficulties in locating the site of the emergency.

Advancements in communication and technology has improved the ability to respond to emergency situations. Systems have been set up for improving response times to emergencies so that emergency personnel, such as paramedics, the police, and the fire department can quickly respond to the particular emergency. In particular, with the recent widespread use of the 9-1-1 emergency telephone system, emergency personnel are provided with the capability to quickly respond to an emergency. Moreover, medical technology has advanced to the point where human health from various traumas can be minimized and lives can now be saved in situations where it was unlikely to do so before.

However, life or death is often measured during those critical moments when emergency personnel are searching for the actual location of the emergency. Of course, once the first emergency vehicle is parked at the location, it serves as a beacon for those following by using some type of rotating light radiating brilliant flashes. Also, the emergency vehicle serves as a warning to passers-by to proceed cautiously. Nevertheless, prior to the emergency personnel reaching the site of the emergency, there is often no means to direct personnel to the site of the emergency or to provide a warning of the emergency itself. Should the personnel responding to the emergency be sufficiently delayed, personal property or human life can be lost regardless of the advances made in medicine and emergency response systems.

For many years, combustible signal flares have been used as emergency signals when a vehicle is in distress or when an accident has occurred at night. Such flares are a fire hazzard, not to mention a hazzard to the individuals using them. Once a flare has been ignited, it is not safe for an individual to move or relocate it. The individual could burn their clothes, or their skin, or injure others. Moreover, combustible flares could ignite spilt fuel or dry brush along the roadside.

A more recent example of a prior emergency signaling device is disclosed in U.S. Pat. No. 5,797,672, entitled SAFETY LIGHT. This device was designed primarily as a temporary replacement for an automobile's tail light, but it has a secondary use as an emergency road signal beacon. The device employs an array of Light Emitting Diodes (LED's) in lieu of an incandescent light in order to provide durability, increase power life and consume less power, thereby permitting operation for a long period of time even though powered by a battery. In contrast, the emergency signaling device of the present invention is more efficient in design and preferably only requires one or more LED's.

Another example of a prior art device is disclosed in U.S. Pat. No. 5,831,522, entitled PORTABLE VISUAL EMERGENCY SIGNAL DEVICE. This prior art device is a triangle shaped light typically used as an emergency road signal or direction beacon. The device of the present invention is smaller and more compact in size, thereby it is more efficient than this prior art device.

Accordingly, there remains a need for a visual signal device that will operate to not only aid emergency personnel to locate an emergency site, but to provide a warning of an emergency condition. Further, due to the fact that emergencies can occur in the home, at work or on vacation, there is always a need for having an emergency signal device on hand so that help can be summoned wherever it is needed. Moreover, it is desirable that the signal device be durable, environmentally safe, available at a reasonable cost and compact in size and operate to unequivocally signal an emergency condition so that lives and property may be protected. Also, it is desirable that the device be mountable on a traffic cone or similar indicator so that the device is more conspicuous. Furthermore, the device should include one of a variety of switches to prolong the useful life of the device. Additionally, the device should be able to be incorporated into many shapes. The present invention fulfils all these needs.

### BRIEF SUMMARY OF THE INVENTION

An object of the present invention is to provide an emergency signaling device that is simple in construction yet durable and safe to use.

Another object of the present invention is to provide an emergency signaling device that is reliable, and is shock resistant as well as water resistant.

Still another object of the present invention is to provide an emergency signaling device that is versatile to use.

A feature of the present invention is the use of light emitting diodes pulsed at a constant rate for producing an emergency signal beacon.

Another feature of the present invention is the use of plastic components that emit light at imperfections in the plastic when light is transmitted along the length thereof, thereby making it possible to provide a light glow completely around the circumference of the device.

These and other objects, which will become apparent as the invention is described in detail below, are provided by a battery-powered emergency signaling device including a housing which encloses a battery pack disposed for providing power to the device. The housing includes a base plate for support of the device and has a cover attached to the base plate for providing a durable impact resistant shell as well as moisture resistant barrier. At least one light emitting diode (“LED”) is pulsed by an electronic circuit, which is powered by the battery. A race is disposed substantially about the periphery of the cover for reflecting light received from the LED.

According to one embodiment of the present invention, the race is formed as an integral part of the cover, which is preferably made of high impact strength polymer such as a clear acrylic plastic material.

In another embodiment of the present invention, the cover includes support members disposed between the base plate and the cover for providing strength to the device.

In another aspect of the present invention, the device includes an anchoring member that allows the device to be mounted on a traffic control cone. The anchoring member advantageously makes the traffic cone more conspicuous.

In still another aspect of the present invention, the device includes a switch. In one embodiment, the switch is a manual-type switch that allows for selective operation of the device. In another embodiment, the switch is a photosensitive-type switch such that the LED's operate automatically during nighttime hours. Both types of switches consequently prolong the operating lifetime of the device.

Still other objects and features of the present invention will become readily apparent to those skilled in the art from the following detailed description, wherein is shown and described only the preferred embodiment of the invention, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive, and what is intended to be protected by Letters Patent is set forth in the appended claims.

### BRIEF DESCRIPTION OF THE DRAWINGS

The general purpose of this invention, as well as a preferred mode of use, its objects and advantages will best be understood by reference to the following detailed description of an illustrative embodiment with reference to the accompanying drawings in which like reference numerals designate like parts throughout the figures thereof, wherein:

FIG. 1 is a perspective view of the emergency signaling device according to the present invention;

FIG. 2 is an exploded view of the emergency signaling device according to the present invention;

FIG. 3 is a side view of an alternative embodiment of the emergency signaling device shown mounted on a traffic cone;

FIG. 4 is a bottom view of an alternative embodiment of the emergency signaling;

FIG. 5 is a perspective view of an alternative embodiment of the emergency signaling device; and

FIG. 6 is a top view of the emergency signaling device of FIG. 5.

### DETAILED DESCRIPTION OF THE INVENTION

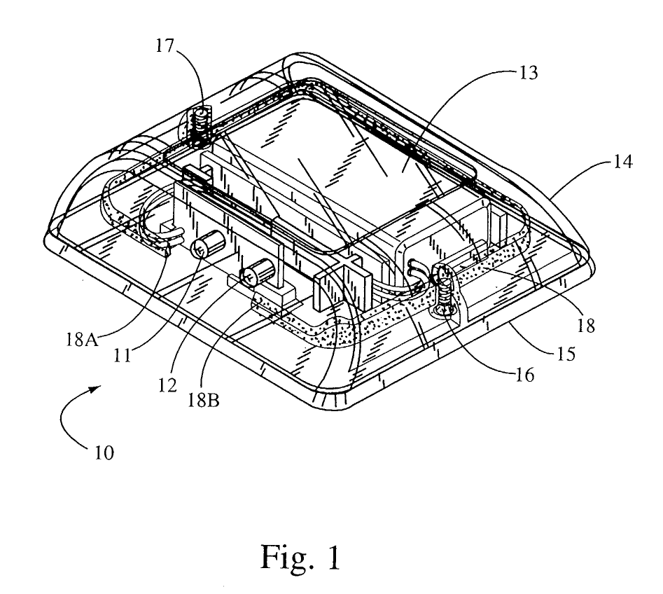

Referring now to the drawings and FIG. 1 in particular, a perspective view of the emergency signaling device 10 of the present invention is shown. Preferably a pair of LED's 11 and 12 are strobed by an electronic circuit, not shown. Such a circuit is well known in the art and will not be amplified further herein. The electronic circuit is powered by batteries within a battery pack 13. The device 10 is covered by a clear acrylic plastic cover 14 secured to a base plate 15 by a pair of screws 16 and 17. The cover 14 has formed therein a race 18 for conducting light emitted by the LED's, as will be shown below. Ends 18A and 18B of the race 18 define a window for transmission of light emitted from the LED's. Also, the ends 18A and 18B receive light from the LED's for transmission through the race 18 as explained below. It is noted that although the race 18 is shown as extending from the inner surface of the cover 14, the device 10 could be alternatively be configured such that the race 18 extends from the outer surface of the cover 14 without departing from the spirit of the invention.

The device 10 makes use of the principle of light reflection, similar to the way light is reflected/transmitted in a fiber optical strand. Imperfections in the plastic race 18 within the device 10, act like tiny mirrors along the plastic race. These tiny mirrors create a multiplicity of reflections, just like the reflection on the inside of a fiber optic cable. One can experience this sort of reflection with a flashlight and a sheet of glass in a dark room. If the flashlight is directed through the glass sheet at a 90 degree angle, it passes straight through the glass. However, if the flashlight is directed at the edge of the glass, the glass will act as a conductor of light. Light travels through the plastic in a similar manner, and is reflected at imperfections (i.e., tiny mirrors) in the plastic race 18. Hence, light from the LED's 11 and 12 is emitted about the circumference of the device 10.

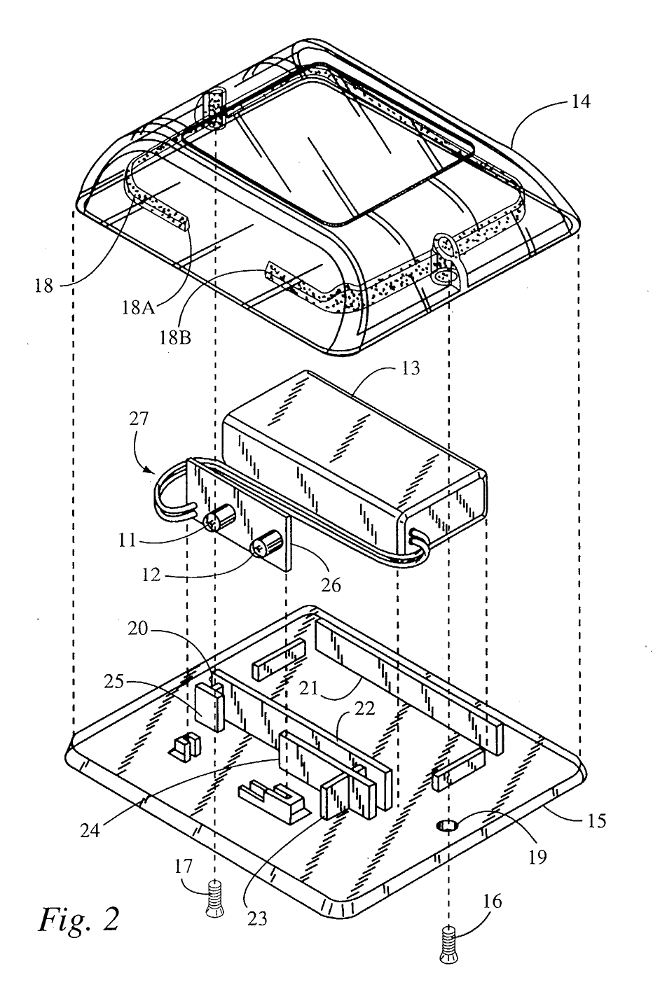

Referring now to FIG. 2, an exploded view of the device 10 of the present invention is shown. The base plate 15 provides support for the device, and when sealed it provides water-tight integrity of the finished device. Openings 19 and 20 are formed in the base plate 15 for receiving the screws 16 and 17, respectively, which secure the base plate 15 to the cover 14. Between the base plate 15 and the cover 14 are located a plurality of vertical braces 21 through 25, which help support the cover 14 when under stress. For example, the device 10 may be placed on the pavement in the vicinity of an accident where it is most likely that a vehicle will run over it, or someone might step on it. Hence, it is prudent to reinforce the device against such eventualities.

According to the disclosed embodiment, the pair of LED's 11 and 12 are disposed on a PC board 26 and are located within the window in the race 18 defined between the ends 18A and 18B of the race 18. It is understood that one could employ only one LED without departing from the scope of the invention hereof. Circuitry (not shown) controlling the LED's 11 and 12 is located on the side of the PC board 26 opposite from the LED's. The batteries contained within the battery pack 13 provide a source of direct current for the LED's 11 and 12 (as well as for the circuitry) by means of wires 27. In accordance with one embodiment, the battery pack 13 includes a pair of AA batteries. Other suitable voltage sources may be used without departing from the scope of the present invention.

Turning now to FIG. 3, an alternative embodiment of the emergency signaling device 10 is shown. The signaling device 10 in this embodiment comprises a anchoring member 50. The anchoring member 50 is cylindrical and extends perpendicularly from the base plate 15 of the device 10. However, the anchoring member 50 could have a variety of other shapes without departing from the spirit of the invention. In one embodiment, the anchoring member 50 is integrally attached to the base plate 15, but in another embodiment, the anchoring member 50 is attached to the base plate 15 via adhesives or other like manner.

Preferably, the anchoring member 50 allows the device 10 to be mounted to a traffic cone 52. The traffic cone 52 is widely known and is typically used to indicate to motorists an area that is off-limits to car traffic. A typical traffic cone 52 is truncated at a top end 56 so as to form a top surface 58, and a round hole 54 extends perpendicularly through the top surface 58. Preferably, the anchoring member 50 is sized so as to fit within the hole 54. For instance, in one embodiment, the outer diameter of the anchoring member 50 measures approximately 1.3 inches. Also as shown, positioning the anchoring member 50 within the hole 54 allows the base plate 15 of the device 10 to rest atop the top surface 58. Thus, since the cone 52 largely encircles the anchoring member 50, the cone 52 inhibits movement of the device 10, and the device 10 is unlikely to fall from the cone 52.

Traffic cones 52 are often placed on roads after an accident or other hazard arises, and the cones 52 communicate to drivers that certain hazardous areas are off-limits. By attaching the device 10 to the traffic cone 52, the pulsating light emitting from the device 10 makes the traffic cone 52 much more conspicuous to drivers. As such, drivers are less likely to drive over the cone and into a hazardous area. Therefore, mounting the device 10 on the cone 52 advantageously increases safety on the roadways.

As is also shown in FIG. 3, a switch 60 is included on the device 10. In the embodiment shown, the switch 60 is a photosensitive switch widely known in the art as being capable of engaging or disengaging a component based upon the intensity of light affecting the switch 60. The switch 60 is positioned on the cover 14 of the device 10, but it could be positioned on other surfaces without departing from the spirit of the invention. Also, the switch 60 is electrically coupled to the battery pack 13. In the preferred embodiment, the switch 60 allows the flow of electricity from the battery pack 13 to the LED's 11, 12 during the night time (i.e., when there is limited amounts of light affecting the switch 60), but the switch 60 substantially stops the flow of electricity from the battery pack 13 to the LED's 11, 12 during the day time (i.e., when there is a large amount of light affecting the switch 60). It is understood that operation of the device 10 is more effective at night, but that operation of the device 10 is relatively unnecessary during the daytime. Thus, the photosensitive nature of the switch 60 shown in FIG. 3 advantageously increases the lifetime of the battery pack 13 by limiting its use to the nighttime, when the device 10 is more effective.

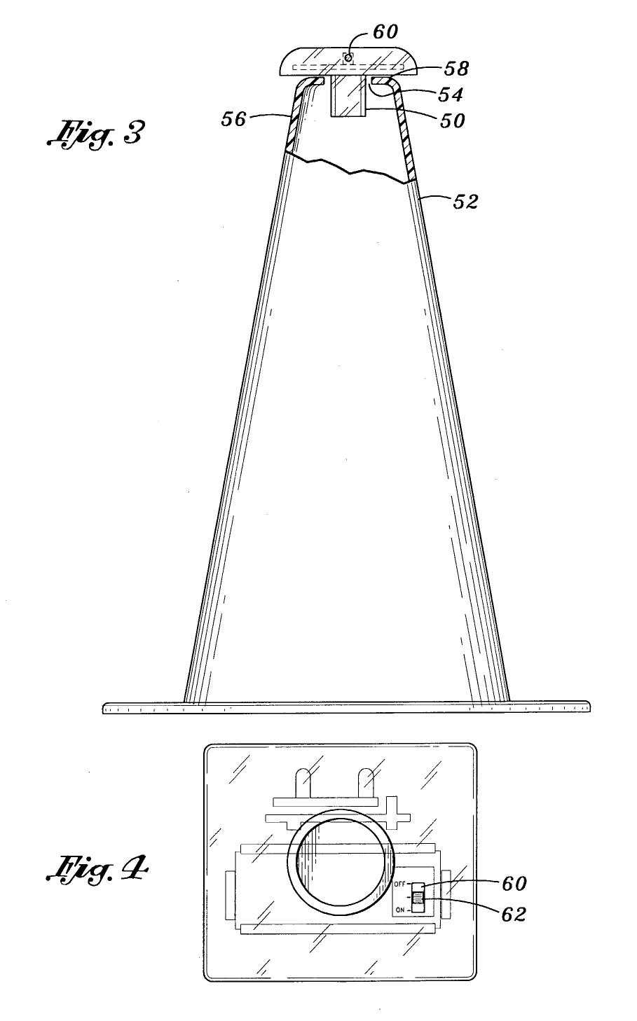

Turning now to FIG. 4, an alternative embodiment of the device 10 is shown. In this embodiment, the switch 60 is of a manual type. The manual switch is widely known in the art for having a lever 62 which can be selectively moved between an “on” position and an “off” position. When in the “on” position, the switch 60 allows electricity to flow from the battery pack 13 to the LED's 11, 12, and when in the “off” position, the switch 60 inhibits the flow of electricity from the battery pack 13 to the LED's 11, 12. The switch 60 is positioned on the base plate 15 such that the lever 62 extends outward therefrom; however, the switch 60 could be positioned elsewhere on the device 10 without departing from the spirit of the invention. As such, a user can selectively turn the device 10 on or off, thereby advantageously extending the operating lifetime of the device 10.

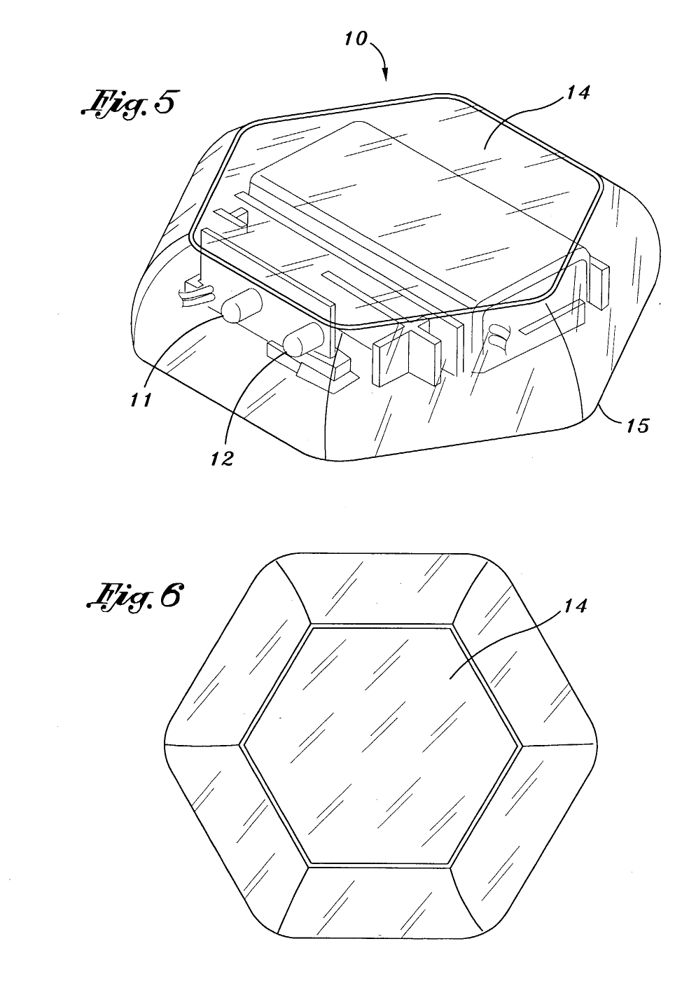

Turning now to FIGS. 5 and 6, an alternative embodiment of the device 10 is shown. This embodiment of the device 10 is largely similar to the embodiments discussed above, except that the cover 14 and base plate 15 are shaped such that the overall shape of the device 10 is a hexagon. In other embodiments (not shown), the device 10 takes on a variety of other shapes, including circular discs, octagons, and the like without departing from the spirit of the invention. Similar to the embodiments described above, a race 18 protrudes from the cover 14 of the device 10 and extends partially around the device 10 such that light emitted from the LED's 11, 12 reflects through the race 18. As such, a user can view the light from many perspectives.

Although the invention has been described with reference to a specific embodiment, this description is not meant to be construed in a limiting sense. Various modifications of the disclosed embodiment as well as alternative embodiments of the invention will become apparent to one skilled in the art upon reference to the description to the invention. It is therefore contemplated that the appended claims will cover any modifications of the embodiments that fall within the true scope of the invention.

What is claimed is:

1. An emergency signaling device comprising:
a. a housing having an inner surface and an outer surface;
b. at least one light emitting diode positioned within the housing and powered by a battery also within the housing, wherein each light emitting diode is capable of emitting a pulsating light;
c. an anchoring member attached to and extending from the outer surface of the housing; and
d. at least one race protruding from the housing and at least partially extending around the device, such that when each light emitting diode emits the pulsating light, the light internally reflects through the at least one race such that the light can be viewed from multiple vantage points around the device.

2. The emergency signaling device of claim 1, wherein the anchoring member is integrally attached to the housing.

3. The emergency signaling device of claim 1, wherein the anchoring member is non-integrally attached to the housing.

4. The emergency signaling device of claim 1, wherein the anchoring member is sized so as to fit within an opening in a traffic cone.

5. The emergency signaling device of claim 4, wherein the anchoring member has a maximum width that falls within the range of 1 to 1.5 inches.

6. An emergency signaling device comprising:
a. a housing having an inner surface and an outer surface;
b. at least one light emitting diode positioned within the housing and powered by a battery also within the housing, wherein each light emitting diode is capable of emitting a pulsating light;
C. a switch electrically coupled to the battery; and
d. a race protruding from the housing and at least partially extending around the device, such that when each light emitting diode emits the pulsating light, the light internally reflects through the race such that the light can be viewed from multiple vantage points around the device.

7. The emergency signaling device of claim 6, wherein the switch is a manual switch.

8. The emergency signaling device of claim 6, wherein the switch is a photosensitive switch.

9. An emergency signaling device comprising:
a. a hexagon-shaped housing having an inner surface and an outer surface;
b. at least one light emitting diode positioned within the housing and powered by a battery also within the housing, wherein each light emitting diode is capable of emitting a pulsating light; and
c. at least one race protruding from the housing and at least partially extending around the device, such that when each light emitting diode emits the pulsating light, the light internally reflects through the race such that the light can be viewed from multiple vantage points around the device.
